(19) United States
(12) Patent Application Publication
(10) Pub. No.: US 2004/0040421 A1
(43) Pub. Date: Mar. 4, 2004

(54) Air valve stem wrench

(76) Inventor: Dwayne Richard Prax, Colorado Springs, CO (US)

Correspondence Address: HANES & SCHUTZ, P.C., 102 S. TEJON ST., SUITE 800, COLORADO SPRINGS, CO, 80903, US

(21) Appl. No.: 10/232,161

(22) Filed: Aug. 30, 2002

(51) Int. Cl. B25B 13/06

(52) U.S. Cl. 81/121.1

(57) ABSTRACT

A wrench for engaging the retaining nut on the air valve stem associated with the inside wheel of a vehicular dual wheel set, comprising, an elongated hollow socket adapted to receive the air valve housing stem, said socket having a closed proximal end and an open distal end and having side walls with inside and outside surfaces, where the inside surfaces of the side walls define the interior shape of at least a portion of the hollow socket as an equilateral polygon, an elongated rigid shaft coaxially attached to the proximal end of the socket and a handle integrally attached to the shaft for rotating the socket.

### FIELD OF THE INVENTION

The present invention relates to hand tools and more particularly to a wrench for engaging and turning the retaining nut that secures the air-valve stem carried by the inside wheel of a dual wheel set of a heavy vehicle.

### BACKGROUND OF THE INVENTION

The elongated stem that houses the air valve of a tubeless tire mounted on the wheel of a heavy truck or bus is secured in place by a retaining nut. Vibration tends to loosen the retaining nut and sufficient loosening will create an air leak, resulting in a flat or blown out tire. To prevent such an undesirable occurrence, it is necessary that the retaining nut be frequently tightened. When tightening the stem on a single wheel, a standard box wrench or end wrench will easily accomplish the task. However, in dual wheel configurations where the valve stem on the inside wheel is only accessible through an air hose access opening in the body of the outside wheel, it becomes impossible to tighten the retaining nut with a conventional wrench. Removal of the outside wheel is the only way to obtain the necessary wrench access to the retaining nut on the inside air valve stem. Because removal of the outside wheel is a time consuming effort, proper maintenance of the inside wheel's valve stem of a dual wheel set is routinely neglected.

U.S. Pat. No. 4,275,622 for Dual Wheel Valve Stem Tool discloses a manual tool designed for a similar purpose, however the wrench of the present invention represents an improvement over the tool disclosed in that patent because it is simpler, easier to use, less expensive to manufacture and functions in a different and more efficient way.

The objective of the present invention is to provide a simple tool that can access the retaining nut on the valve stem of the inside wheel of a dual wheel set.

### DESCRIPTION OF THE DRAWINGS

FIG. 1 is a side view of the wrench of the present invention.

FIG. 2 is a cross sectional view taken along lines 2-2 of FIG. 1.

FIG. 3 is a cross sectional view of a typical dual wheel set showing the tool of the present invention being inserted through the air hose access opening in the outside wheel.

FIG. 4 is a cross sectional view of the dual wheel set of FIG. 3, showing the tool of the present invention engaged on the retaining nut of the valve stem on the inside wheel.

FIG. 5 is a fragmentary cross sectional view of the portion of the inside wheel that mounts the air valve stem for the tubeless tire that is mounted on that wheel, showing the air valve and its retaining nut.

### DETAILED DESCRIPTION OF THE INVENTION

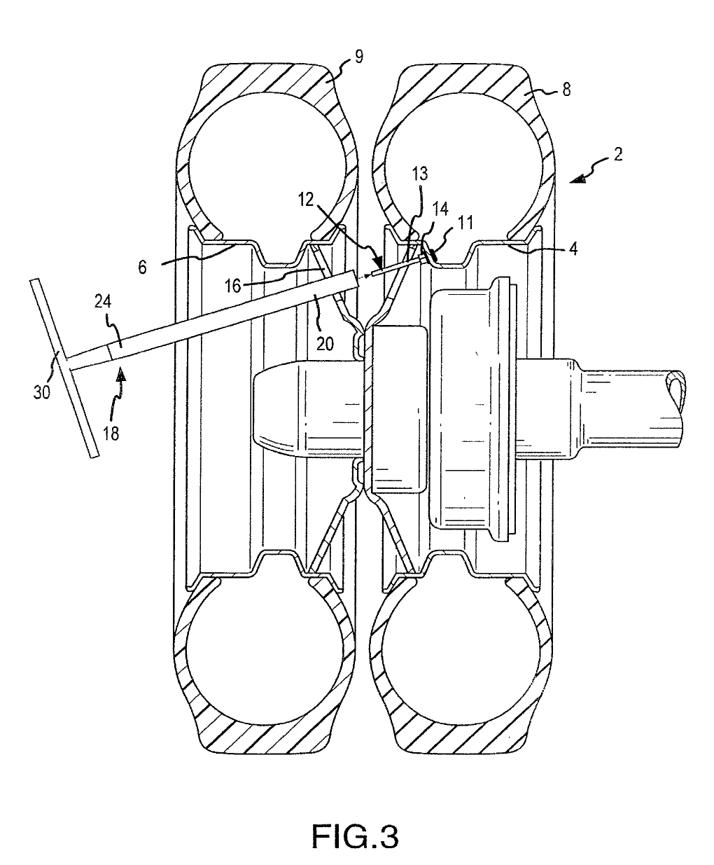

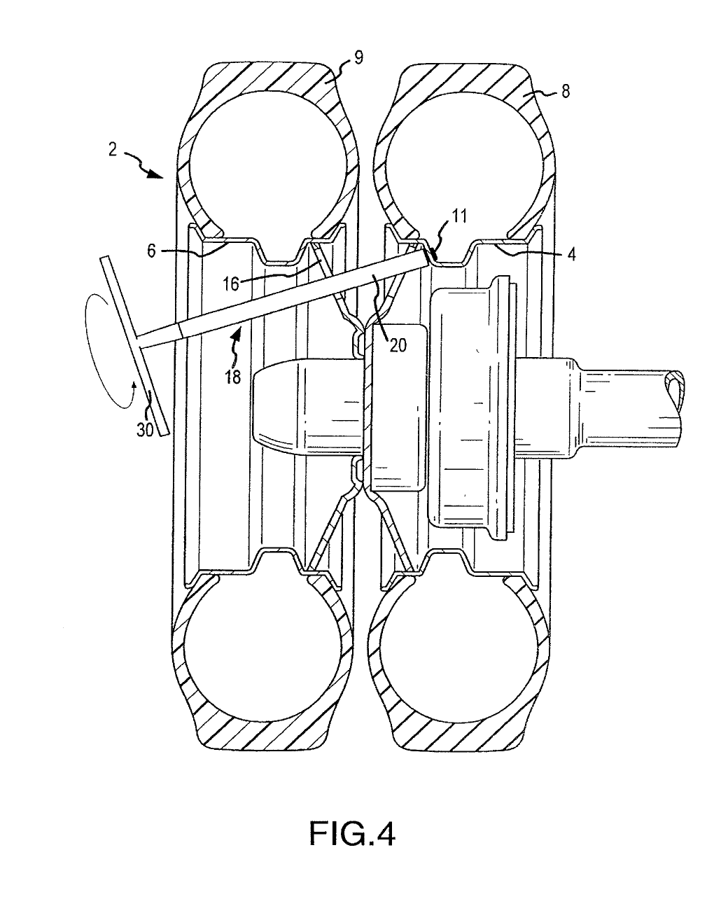

A typical dual wheel set 2 found on heavy trucks and buses is illustrated in FIGS. 3 and 4. The set comprises an inside wheel 4 and an outside wheel 6. Tubeless tires 8 and 9 are mounted on the respective wheels 4 and 6. An elongated valve stem 12 includes a cylindrical housing 13 that carries an air valve (not shown in the drawings) in its interior, a rubber seal surrounding the lower part of the stem that engages the sides of the aperture in the wheel through which the valve stem extends and a base 11 that is located in the interior of the tubeless tire 8. The valve stem, its interior valve and the base provide an air passageway through which air passes into the interior of the tubeless tire 8. The stem 12 is mounted in the wheel from the interior so that the base 11 provides a stop, preventing the valve from coming out of the wheel aperture. On the outside of the wheel 4 the valve stem 12 is fitted with threads and a cooperating retaining nut 14 that may be tightened against the outside surface of the wheel in order to maintain the valve stem secured in its position in the wheel.

As seen in FIG. 3, the body of the outside wheel 6 is provided with a hole 16 through which the end of an air hose can pass to be applied to the distal end of the valve stem in order to inflate the inner tire 8. Except for the air hose entry hole 16, the body of the outside wheel substantially shields the valve stem 12. The opening 16 is insufficient in size to accommodate a traditional hand wrench, much less permit the hand access necessary to operate the wrench for tightening the retaining nut 14. Standard socket wrenches will not work for that purpose because they cannot accommodate the length of the valve stem. Thus, in order to provide the necessary operating space to tighten the retaining nut 14 on the inside wheel 4, the outside wheel 6 must be removed. Removal of the outside wheel 6 is a tedious and time consuming job just to check or tighten the retaining nut on the valve stem of the inside wheel. However, if the valve stem retaining nut loosens, the valve stem is no longer sealed and air will escape from the inside wheel.

The wrench 18 of the present invention solves the problem by providing immediate access to the retaining nut 14 through the opening 16 in the outside wheel 6, as shown in FIGS. 3 and 4. The wrench 18, comprises an elongated interior socket 20 into which may be inserted the elongated valve stem 12, preparatory to operating on the retaining nut 14. The open distal end 21 of the socket 20 contains side walls 22, the interior of which define an equilateral polygon that fits snugly around the perimeter of the retaining nut 14, as with a traditional socket wrench. The closed end of the elongated socket 20 and the sidewall 22 is elongated into a solid shaft or shank 24 having a perpendicularly disposed handle 30 attached to its proximal end. The shank 24 is made sufficiently long so that when the open end of the socket 20 engages the retaining nut 14 the handle 30 will be well clear of the outside wheel 6 in order to give the operator adequate room to freely turn the wrench to tighten the retaining nut.

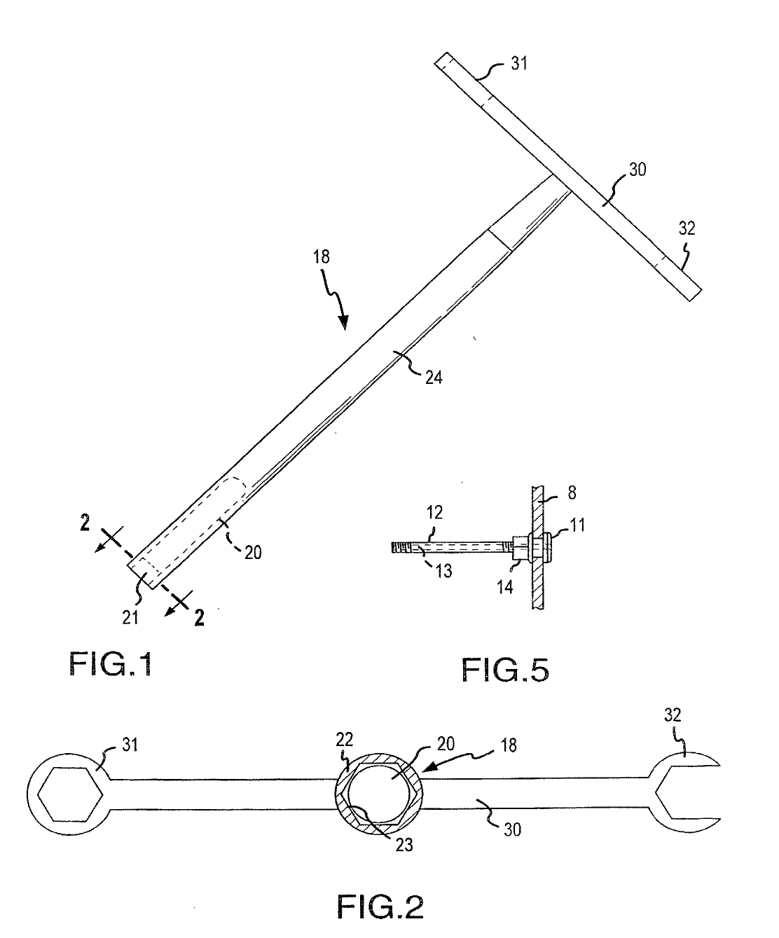

To expand the uses of the wrench, especially with respect to operations on the valve stem of the outside wheel, one end of the wrench handle 30 is preferably provided with a box wrench 31. The other end of the handle 30 is provided with an open end wrench 32, as best shown in FIG. 2.

What is claimed is:

1. A wrench for engaging the retaining nut on a tire air valve stem, comprising,
an elongated hollow socket adapted to receive an air valve stem, said socket having a proximal closed end and an open distal end and having side walls with inside and outside surfaces, where the inside surfaces of the side walls define the interior shape of at least a portion of the hollow socket as an equilateral polygon,
an elongated rigid shaft coaxially extending from the closed proximal end of the socket, and
handle means integrally attached to the shaft for rotating the socket.

2. The wrench of claim 1 where the handle means comprises a rigid bar that is attached perpendicularly to the shaft at the mid-point of the bar.

3. The wrench of claim 2 where the handle has first and second ends and where the first end is enlarged with a central closed aperture having polygonal shaped sides.

4. The wrench of claim 2 where the handle has first and second ends and where the second end is enlarged with a central open sided aperture having polygonal shaped sides.

5. A tool for operatively engaging a retaining nut at the base of an elongated stem, comprising,
at least one elongated socket having inside and outside surfaces, the shape and size of the inside surface adapted for operative engagement with a retaining nut at the base of the elongated stem,
an elongated shank coaxially connected to the socket, and
a handle connected to the shank for rotating the shank and the socket.
